(19) United States
(12) Patent Application Publication
(10) Pub. No.: US 2007/0136335 A1
(43) Pub. Date: Jun. 14, 2007

(54) Method and system for multiple independent extensions of a concept taxonomy via description logic classification

(76) Inventors: Robert Dionne, Ridgefield, CT (US); Richard Mathes, Ridgefield, CT (US); Eric Mays, Ridgefield, CT (US); Robert Anthony Weida, New York, NY (US); Jason Vincent Weis, New Milford, CT (US)

Correspondence Address: JACKSON WALKER LLP, 901 MAIN STREET, SUITE 6000, DALLAS, TX, 75202-3797, US

(21) Appl. No.: 11/297,990

(22) Filed: Dec. 9, 2005

(51) Int. Cl. G06F 7/00

(52) U.S. Cl. 707/101

(57) ABSTRACT

A method and system facilitating multiple independent extensions of a concept taxonomy. Separate classification operations determine how one or more distinct sets of additional concepts, each comprising an extension, fit in with the original taxonomy while leaving the original taxonomy intact and substantially without copying it. Classification results are recorded so that the original taxonomy and every extension thereof can be independently queried and retrieved on demand. This process is referred to as modular classification.

### FIELD OF THE INVENTION

The present invention relates to classification operations used with taxonomies.

### BACKGROUND OF THE INVENTION

Descriptive Logics (“DL”) is a well known field of study, also known as terminological logics, term subsumption systems, KL-ONE-like systems and the like, within the area of knowledge representation. DL is a type of formal logic that focuses on creating descriptions of concepts and reasoning about them effectively. For example, DL is ideal for expressing precise descriptions of medical concepts, including anatomy, diseases, drugs, procedures, and the like. DL enables clear and unambiguous definition of a concept's meaning, primarily in terms of its relationships with other concepts. A given concept, for example, representing a class of drugs, can be described succinctly by naming the concepts it specializes, i.e., more general classes of drugs, and introducing distinguishing characteristics such as relationships to its ingredients. The logical consistency of an entire set of concepts, such as a medical terminology, is automatically tested and enforced. Moreover, logical consequences that are implicit in the given descriptions are automatically made explicit.

A particular DL provides a language for describing concepts and a repertoire of logical inferences for reasoning about them. Examples of DL languages include OWL and Applicant's Ontylog. Among the most powerful aspects of DL are its facilities for reasoning about relationships among concepts and thus automatically managing a logically consistent taxonomy of concepts.

A small, conventional concept taxonomy is shown in FIG. 1. Each line connects a concept to a more general concept above and thus represents an “is-a” relationship. For example, a Plant is-a Living Thing, or equivalently, Living Thing is a generalization of Plant. Only direct relationships are shown. Although a Reptile in fact is a Living Thing, that indirect relationship can be inferred from the facts that a Reptile is an Animal, and an Animal is a Living Thing.

The well known DL classification operation automatically organizes a set of concepts into a taxonomy based on their logical descriptions. Computer software which implements the classification operation is called a classifier. For example, as seen in FIG. 2, a set of concepts {A, B, C, D, E, F, G, H, I, J) might be classified into a taxonomy where A is a generalization of B, C and D; B is a generalization of E, F and G, and so on. This taxonomy will be used throughout this disclosure. Extant classifiers generally create an explicit representation of a taxonomy, including explicit information corresponding to each of the lines shown between pairs of linked concepts.

As a result of classification, each concept in the taxonomy is guaranteed to be more specific than its parents which are directly connected concepts above it and other ancestors which are indirectly connected concepts above it, as well as more general than its children, which are directly connected concepts below it and other descendants which are indirectly connected concepts below it. Therefore, concepts are always found in predictable, as opposed to arbitrary, locations. In this manner, relationships are easily visualized among concepts, and unintended results can be quickly identified. Well-organized taxonomies allow medical knowledge, such as advice, rules, warnings, arbitrary codes, and the like, to be associated with concepts at the most appropriate level in the taxonomy, e.g., neither too general nor too specific, and appropriately inherited by, i.e., implicitly associated with, descendant concepts.

A terminology is a collection of concepts, and a namespace is a set of concepts that are managed as a group. Thus, one can classify the set of concepts comprising a namespace into a taxonomy. Often, an entire terminology is contained and thereby managed in one namespace. For example, all the concepts shown in FIG. 2 might comprise a single namespace. Alternatively, as is done conventionally, terminologies can be composed by “importing” one namespace, and hence the concepts therein, into another namespace.

Conventional concepts in DL include: Classification, i.e., organizing a given set of descriptions into a taxonomy based on subsumption via DL; Reclassification, i.e., reorganizing a given set of descriptions already in taxonomy, also based on subsumption via DL, following changes to one or more of the descriptions; Importing namespaces, i.e., implicitly copying the contents of one or more previously specified namespaces into a new namespace as described in this section; Redundant representations of a DL taxonomy, e.g., a classification graph and relational database tables, as in applicant's Terminology Development Environment (TDE) product; A terminology server for a DL taxonomy, e.g., as proposed by Alan Rector, et al; a terminology server capable of classification, e.g., Network Inference's Cerebra product; A standard classification service, such as the DIG interface to RACER.

Referring now to FIG. 3, the concepts explicitly comprising each of three distinct and not yet classified namespaces are illustrated. As seen therein, namespace 1 explicitly consists of concepts K, L and M; namespace 2 explicitly consists of concepts O, P, Q, R and S, and namespace 3 explicitly consists of concepts N and T. It is stipulated that namespace 2 imports namespace 1, and similarly that namespace 3 imports namespace 1. As such, namespace 2 implicitly consists of concepts from both namespaces 1 and 2; and namespace 3 implicitly consists of concepts from both namespaces 1 and 3: Specifically, namespace 2 implicitly consists of concepts K, L, M, O, P, Q, R and S, and namespace 3 implicitly consists of concepts K, L, M, N and T. Since namespaces 2 and 3 both import namespace 1, they both depend on namespace 1, as suggested by the dashed line separating them from namespace 1. However, they are independent of each other as suggested by the solid line between them. As a result, three different namespaces can be classified: namespace 1 (alone); namespace 2 (with concepts from namespace 1 implicitly included) and namespace 3 (with concepts from namespace 1 implicitly included). Resulting taxonomies are shown respectively in FIGS. 4, 5, and 6, with imported concepts shaded. In FIGS. 4, 5 and 6 each of the three taxonomies includes a separate copy of a common “upper structure” consisting of K, L and M-the classified concepts from namespace 1.

Importantly, conventional systems make no provision for sharing a single copy of the common structure, and this limitation becomes increasingly significant as the size and complexity of the common structure increases, due to storage requirements for recording the structure of a taxonomy, as well as processing requirements for initially organizing and then maintaining the taxonomy via classification operations.

### SUMMARY OF THE INVENTION

The present invention achieves technical advantages by facilitating multiple independent extensions of a concept taxonomy based on DL. Separate classification operations determine how one or more distinct sets of additional concepts, each comprising an extension, fit in with the original taxonomy (a generalization hierarchy or “is-a” hierarchy) while leaving the original taxonomy intact and substantially without copying it. Classification results are recorded so that the original taxonomy and every extension thereof can be independently queried and retrieved on demand. As a result, conventional DL taxonomies such as SNOMED CT® can be extended efficiently and accurately, using the same language as the original, in multiple independent ways, to meet local and/or specialized needs in a timely manner. This process is referred to as modular classification.

### BRIEF DESCRIPTION OF THE DRAWINGS

FIG. 1 illustrates a small, conventional concept taxonomy;

FIG. 2 illustrates a set of concepts classified into a taxonomy;

FIG. 3 illustrates the concepts explicitly comprising each of three distinct namespaces;

FIG. 4 is a first sample resulting technology;

FIG. 5 is a second sample resulting technology;

FIG. 6 is a third sample resulting technology;

FIGS. 7A, 7B and 7C illustrate a base namespace and sample extensions;

FIG. 8 illustrates multiple types of extensions to the SNOMED CT namespace; and

FIG. 9 illustrates the extension of the base taxonomy with another namespace.

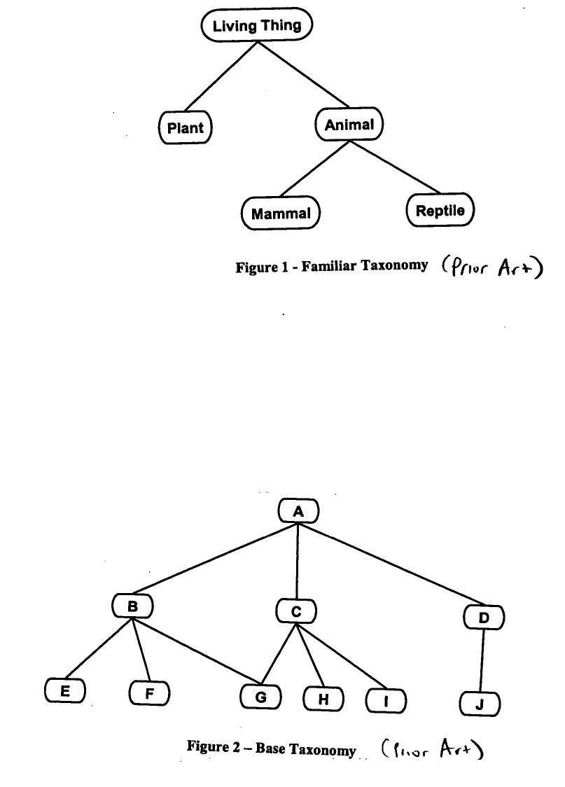

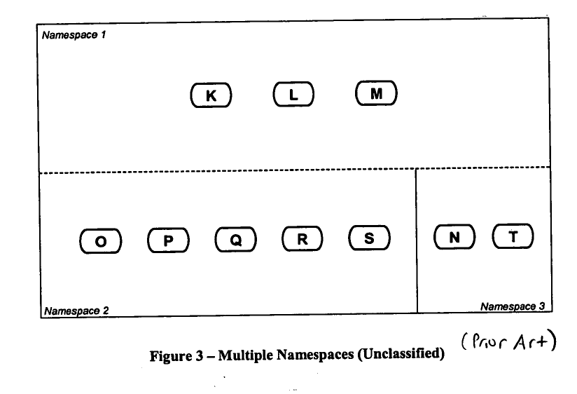

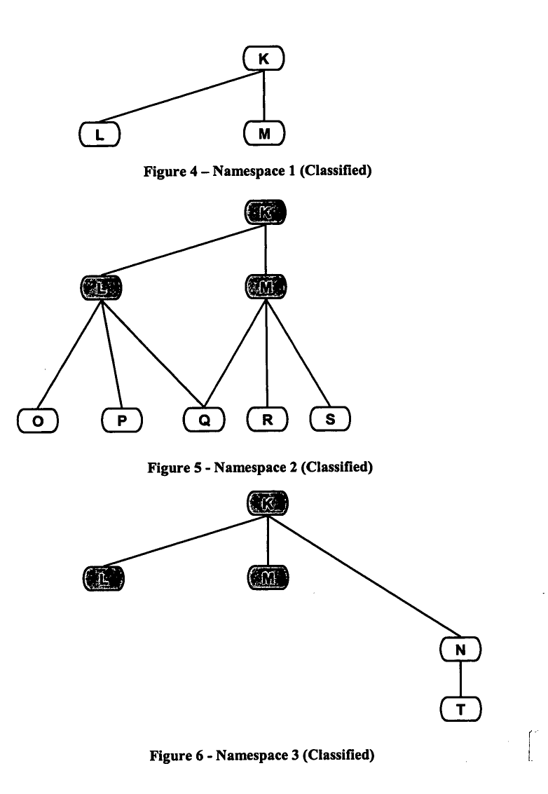

### DETAILED DESCRIPTION OF AN EXEMPLARY EMBODIMENT

An important motivation for the present invention arises from the existence of large, authoritative terminologies together with the desire of users to adapt them in diverse ways. For example, SNOMED CT is a comprehensive medical terminology which contains hundreds of thousands of concepts. SNOMED CT is developed and published under the auspices of the College of American Pathologists (“CAP”). As of the date hereof, new versions of SNOMED CT are released twice yearly.

Different users of SNOMED CT may desire to extend SNOMED CT by adding their own or their organization's concepts. It would not be uncommon for a single user to be interested in extending SNOMED CT several different ways. However, it is important to distinguish the original SNOMED CT as authoritatively published by CAP from any extensions created by CAP or by others. The present invention is adapted to manage terminology extensions without requiring undue amounts of computer storage or processing.

The present invention is operable to provide an effective means for working with multiple independent extensions of an existing taxonomy while preserving the integrity of the original taxonomy.

As used herein, a base namespace refers to an existing, namespace, e.g., a namespace containing SNOMED CT. Concepts therein are referred to as base concepts. Then, an extension namespace contains one or more additional concepts to be classified, viewed, and otherwise used as if they were also part of the base namespace, but without altering (or entirely copying) the base namespace. Concepts within an extension namespace are referred to as extension concepts. As an example, the fictitious Anytown Hospital may wish to extend the SNOMED CT base namespace with an Anytown Hospital extension namespace. That extension namespace may include an extension concept for a (fictitious) new medication, Dr. Washington's Aspirin Formulation, with an is-a relationship to the Aspirin (product) base concept in SNOMED CT. In general, an extension concept can be defined in terms of its relationships to base concept(s) and/or fellow extension concept(s).

Referring now to FIGS. 7A, 7B and 7C, FIG. 7A shows a much simpler sample taxonomy for a base namespace. This simple structure is shown for clarity and brevity (SNOMED CT has hundreds of thousands of concepts). FIGS. 7B and 7C are two independent extensions. In FIG. 7B, the taxonomy is extended with a namespace consisting of concept X1 and in FIG. 7C, the taxonomy is extended with a namespace consisting of concept X2. This extended taxonomy effectively contains the entire set of concepts from the base namespace augmented with additional concept(s) from the extension namespace. The dashed lines in FIGS. 7B and 7C are intended to suggest that while the relationships of the extension concepts to the base taxonomy have been determined, they are not permanently spliced into the original base taxonomy, which is shown with solid lines. As seen in FIGS. 7A, 7B and 7C, a base namespace may have multiple extensions with each of the extensions independent of each other.

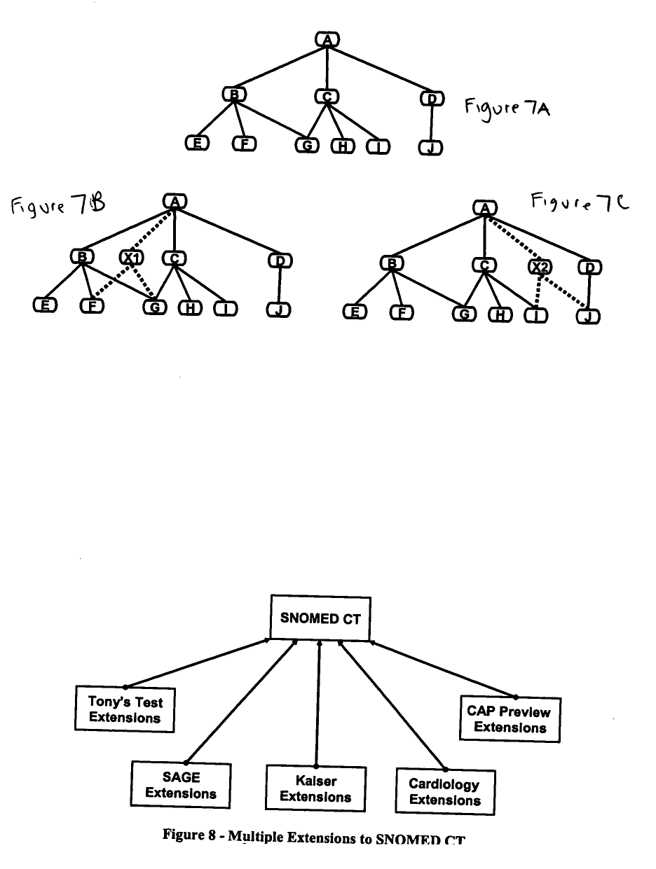

FIG. 8 shows multiple independent, hypothetical namespaces extending a SNOMED CT namespace. Extensions might have a variety of custodians and purposes, including an individual, e.g., Tony, for testing; a project, e.g., SAGE, for research; an organization, e.g., Kaiser-for specific institutional needs; a specialty society, e.g., the American College of Cardiology, for terminology related to their practice area; or the creators of the base namespace themselves, such as CAP, to preview possible future enhancements to the base.

Data Structures

In this section, the data structures of the present invention which are used to create and record the results of classifying an extension namespace, together with usage of the data structures to retrieve the results, are described. Later, the overall processes for classifying and maintaining an extension namespace is described.

Referring again to the term concepts, each concept is assigned a unique global identifier (“GID”) that is distinct from all other concepts in all namespaces under consideration. Hence, no two concepts under consideration have the same GID. Each namespace is also assigned a unique GID.

To record the relationships between extension namespaces and their base namespaces, a straightforward table, called an extension table, is used to pair each extension namespace GID with its base namespace GID. As seen in Table 1 below, an exemplary embodiment uses a base namespace with GiD 100 and three namespaces for extensions thereof, with GIDs 101, 102 and 103. Those relationships are captured in the following extension table:

TABLE 1

| Extension Namespace GID | Base Namespace GID |
|---|---|
| 101 | 100 |
| 102 | 100 |
| 103 | 100 |

The identity and definition of concepts are recorded in database tables. For each base namespace, a classification graph is also created. A classification graph is a graph data structure composed of nodes (vertices) which represent concepts, along with arcs (edges) which explicitly represent parent-child relationships comprising the concept taxonomy and other inter-concept relationships. The classification graph is a convenient and efficient representation for use by the classifier during classification operations. Such graphs are conventionally known. The present invention does not require any particular form of classification graph. An entire classification graph can be stored in a relational database as a “blob” and loaded into a computer's primary memory on demand. In fact, the classification graph can be embedded in an object of an object-oriented programming system such as Java, and the entire object can be serialized as a “blob”.

For each base namespace, its taxonomy is redundantly recorded in rows of a relational database table, referred to as a parentage table. The parentage table advantageously allows convenient and efficient retrieval of parents and/or children of specific concepts, e.g., by a graphical browser application that displays the taxonomy. Each row contains a GID for a child concept, a GID for a parent of that concept, and the GID for their namespace. There is one row for each parent-child relationship.

Reffering again to FIG. 7A, assume the GID of the base namespace is 100. Its taxonomy could be recorded in a Parentage table as shown in Table 2 below, where rows are numbered for reference and a concept GID is denoted by prefixing its name with a '#:

TABLE 2

| Child GID | Parent GID | Namespace GID |
|---|---|---|
| #B | #A | 100 |
| #C | #A | 100 |
| #D | #A | 100 |
| #E | #B | 100 |
| #F | #B | 100 |
| #G | #B | 100 |
| #G | #C | 100 |
| #H | #C | 100 |
| #I | #C | 100 |
| #7 | #D | 100 |

Table 2 can be augmented with additional rows as discussed herein. The consolidated Parentage table for examples presented herein is shown in Table 3. (Rows are numbered on the beft for reference, but the row numbers are not part of the table.)

TABLE 3

| Child GID | Parent GID | Namespace GID |
|---|---|---|
| #B | #A | 100 |
| #C | #A | 100 |
| #D | #A | 100 |
| #E | #B | 100 |
| #F | #B | 100 |
| #G | #B | 100 |
| #G | #C | 100 |
| #H | #C | 100 |
| #I | #C | 100 |
| #J | #D | 100 |
| #X1 | #A | 101 |
| #F | #X1 | 101 |
| #G | #X1 | 101 |
| #X2 | #A | 102 |
| #I | #X2 | 102 |
| #J | #X2 | 102 |
| #X3 | #B | 103 |
| #X4 | #X3 | 103 |
| #G | #X4 | 103 |
| #E | #B | 103 |
| #F | #B | 103 |
| #G | #C | 103 |

1
2
3
4
5
6
7
8
9
10
11
12
13
14
15
16
17
18
19
20
21
22

The steps for the retrieval of parents in a base namespace proceeds as follows: first, selected all rows from the parentage table where the given concept GID appears as the child GID entry and the given base namespace GID appears as the namespace GID entry; second, retrieve the corresponding Parent GID entries. The steps for the retrieval of parents in a base namespace proceeds as follows: first, select all rows from the parentage table where the given concept GID appears as the parent GID entry and the given base namespace GID appears as the namespace GID entry, second, retrieve the corresponding Child GID entries.

For each extension namespace, additional rows for each parent-child relationship involving an extension concept therein is recorded. Consider the extended taxonomies for the namespaces shown in FIGS. 7B and 7C and assume their GIDs are 101 and 102, respectively. Then the taxonomy extensions for the extended namespaces could be captured in the same table with the additional rows as seen in Table 4:

TABLE 4

| Child GID | Parent GID | Namespace GID |
|---|---|---|
| #X1 | #A | 101 |
| #F | #X1 | 101 |
| #G | #X1 | 101 |
| #X2 | #A | 102 |
| #I | #X2 | 102 |
| #J | #X2 | 102 |

11
12
13
14
15
16

In the preceding example, several parent-child relationships for the extension concepts are added to the parent-child relationships from the base namespace. Notice that there is one additional row for each dashed line in FIGS. 7B and 7C.

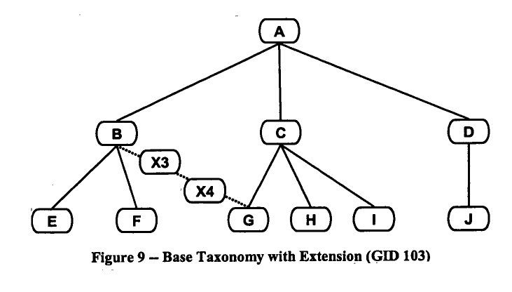

It is also possible that classification of an extension namespace may interpose extension consept(s) between concepts that have direct parent-child relationships in the base namespace. For example, referring to FIG. 9, the base taxonomy is extended with another namespace consisting of concepts X3 and X4 which both classify between B and G.

Assuming that namespace has GID 103, these classification results can be recorded in the parentage table with additional rows as seen in Table 5:

TABLE 5

| Child GID | Parent GID | Namespace GID |
|---|---|---|
| #X3 | #B | 103 |
| #X4 | #X3 | 103 |
| #G | #X4 | 103 |

17
18
19

Thus, one row for each parent-child relationship involving an extension concept in the extension namespace has been added. A complete set of such rows is sufficient to retrieve the parents and children of a given extension concept, which can only appear in one extension namespace, as follows: To identify all the parents of a given extension concept, all rows from the parentage table where the given extension concept GID appears as the child GID entry is selected, then the corresponding parent GID entries are retrieved. To identify all the children of a given extension concept, all rows from the parentage table where the given extension concept GID appears as the parent GID entry are selected, then the corresponding child GID entries are retrieved.

However, retrieval of parents and children for a given base concept in a given extension namespace is more complex. Referring again to FIG. 9, some observations regarding children (and similarly parents) of a base concept such as B in an extension namespace can be made: Its children may include base concepts such as E and F as well as extension concepts such as X3. Some concepts, such as E and F, which were children in the base namespace remain children of the same parents in the extension namespace. Other concepts, such as G, which were children in the base namespace are not children of the same parents in the extension namespace due to one or more interposed extension concepts, such as X3 and X4.

One method to address these observations is to ensure that if the parentage table lists a child for a particular base concept in a particular extension namespace, then all of its other children, from both the base and extension namespaces, are listed for that namespace as well. Thus, all the children of a given concept can be identified preferably from rows for the extension namespace, or failing that, from rows for the base namespace. In the case of namespace 3, we therefore add rows for the base concept children of B as seen in Table 6:

TABLE 6

| Child GID | Parent GID | Namespace GID |
|---|---|---|
| #E | #B | 103 |
| #F | #B | 103 |

20
21

As a result, some parent-child relationships already recorded in rows for the base namespace are repeated in similar rows for the extension namespace. This approach requires storage space to simplify processing. In general, it is expected that the number of extension concepts will be small relative to the number of base concepts, and furthermore that the extension concepts will often be related to one another, e.g., by creating a new sub-taxonomy of extension concepts. Thus relatively few base concepts will have extension concept children and the duplication will be relatively small.

Following similar reasoning, if the Parentage table lists a parent for a particular base concept in a particular extension namespace, then it is ensured that all of its other parents are listed for that namespace as well. Thus, all the parents of a given concept can be identified preferably from rows for the extension namespace, or failing that, from rows for the base namespace. In the case of namespace 3[103], a row for the base concept child of G is added as seen in Table 7:

TABLE 7

| Child GID | Parent GID | Namespace GID |
|---|---|---|
| #G | #C | 103 |

22

It has been disclosed herein as to the method of retrieving parents and children for an extension concept. The process for identifying all the parents of a given base concept in a given extension namespace, is as follows, and referring back to Table 7: As a first step, select all rows from the parentage table where the given base concept GID appears as the child GID entry and the given extension namespace GID appears as the namespace GID entry, and then retrieve the corresponding parent GID entries. If no rows were selected in the first step, then, pursuant to a second step, to identify the relevant base namespace, select the row from the extension table where the given extension namespace GID appears as the extension namespace GID entry, then retrieve the corresponding base namespace GID entry. In a third step, select all rows from the parentage table where the given base concept GID appears as the child GID entry and the just retrieved base namespace GID appears as the namespace GID entry, and then retrieve the corresponding parent GID entries. For example in Table 7:

Given #G and the extension namespace GID 103, pursuant to the first step, select row 19 and 22 of the parentage table and retrieve #X4 and #C; Given #B and the extension namespace GID 103, pursuant to the second step, retrieve base namespace GID 100, then pursuant to a third step, select row 1 of the parentage table and retrieve #A. The process for identifying all the children of a given base concept in a given extension namespace is a straightforward analogue of the preceding process for identifying all the parents.

Overall Process

Several steps are involved in preparation and classification of base and extension namespaces. A base namespace must be prepared before any namespace which extends it. Also, a base namespace must be classified before any namespace which extends it.

Process for Preparing a Base Namespace

The following is the process for preparing a base namespace: First, create a base namespace and assign it a unique GID; second, define an initial set of concepts within the base namespace, i.e., record their identities and definitions in the database associated with the base namespace GID; third, using a conventional classification process, create a classification graph based on the definitions of concepts within the base; fourth, store it in the database.

Fifth, traverse every parent-child relationship in the classification graph, starting from a distinguished root, and (a) create a row in the parentage table for each such relationship with each row containing the child GID, the parent GID, and the base namespace GID and (b) in a conventional manner, record other information inferred about each concept It is noted that the present invention separately includes methods with respect to how to proceed when the base namespace is updated in ways that materially impact an extension namespace.

Process for Preparing an Extension Namespace

The following is the process of preparing an extension namespace: First, create a row in the extension table with the just assigned GID in the extension namespace GID column and the GID of the desired base namespace in the base namespace GID column; second, define an initial set of concepts within the extension namespace i.e., record their identities and definitions in a conventional database, associated with the extension narnespace GID; third, classify the extension namespace as hereinafter described.

Process for Classifying an Extension Namespace

The following is the process of classifying an extension namespace: First, retrieve the classification graph for the desired base namespace from the database and load it into primary memory; second, update the classification graph in primary memory by classifying each concept from the extension namespace, thus adding one node per extension concept to the classification graph; third, for each node N representing an extension concept in the classification graph, (a) For each parent P of N (i) For each child C of P (including N) (1) create a row in the parentage table containing the GIDs for C, P and the extension namespace (b) for each child C of N. For each parent P of C (including N) (1) Create a row in the parentage table containing the GIDs for C, P, and the extension namespace.

Process for Updating an Extension Namespace

The following is the process for updating an extension namespace: First, redefine the set of concepts within the extension namespace, i.e., (a) add new concepts by recording their identities and definitions in the database, associated with the extension namespace GID, and/or (b) modify existing concepts by updating their definitions in the database, and/or (c) delete existing concepts by removing their identities and definitions from the database. Second, remove all rows for the extension namespace from the parentage table and third, classify the extension namespace as described above.

Additional Exemplary Embodiments and Aspects

The methods described above can be implemented using a computer and software combination. As described throughout this disclosure, computer and software refers to any appropriate hardware/software combination, the hardware comprising a computer, controller or micro-controller having at least a processor, memory, data busses and input/output (“I/O”) capabilities. While the hardware may be hardwired to perform their activities, in the present invention, such hardware preferably has its physical states and characteristics defined by machine code which may be stored or embedded in memory and processed by the processor. The machine code derives from source code that is compiled. The machine code, the source code and programs from which it is derived, the protocols necessary to transmit and receive information, any applicable operating system and device drivers and the like, may be referred to generally as software, programs or application(s). The use of the modular classification methods of the present invention in a computer and software environment benefits from a defined Application Programming Interface (API) for invoking modular classification and for accessing the results of modular classification programmatically; the ability to have a graphical user interface (GUI) for invoking modular classification and accessing the results of modular classification visually, and a means for reconciling extensions when a base namespace changes.

Application Programming Interface

An API implements the operations required to prepare for, carry out, and utilize the results of modular classification of the present invention. For example, software can be programmed to create an extension namespace, associate it with a base namespace, populate it with extension concepts defined directly or indirectly in terms of base concepts, extend the base classification graph by integrating additional nodes as a result of classifying the extension concepts, save the classification results, query them, and the like.

Graphical User Interface

A GUI highlights extensions to a base namespace by rendering an integrated view of the extension namespace, where visual cues based on typeface and/or color, etc., distinguish extension concepts from base concepts. A so-called “tree walker” interface allows a user to traverse the extended taxonomy, and other relationships, typically stepping seamlessly from base concepts to extension concepts and vice versa while readily recognizing them as such.

Change Management and Exception Reporting

When a base namespace is changed, for example, if a new version of SNOMED CT is released, one can generate reports concerning adversely affected portions of all associated extension namespaces. For example, such reports can identify any extension concepts which reference a base concept that has been deleted, i.e., does not appear in the latest version.

The present invention is adapted to, among other things, (a) classify an extension to a base namespace by updating the classification graph for the base namespace according to the extension, recording the results (such as parent-child relationships) separately from the classification graph (e.g., in database tables), then discarding updates to the classification graph and reverting to the original on demand; (b) represent multiple independent extensions of a base namespace so that the base classification graph and/or any extension thereof may be accessed on demand without making persistent copies or re-creations of the entire base classification graph (but perhaps loading it into memory); (c) represent multiple independent extensions of a base namespace so that the base taxonomy and/or any extension taxonomy may be accessed on demand from suitable database tables without copying or recreating (all the) rows for the base namespace; and (d) explicitly manage the relationship between a base namespace and one or more extension namespaces to facilitate the preceding. The present invention includes the computer hardware and software for implementing the foregoing, including an API for any or all of the preceding and a GUI for any or all of the preceding. The present invention comprises a modular classification software service which implements modular classification operations for client software such as for a terminology server, which in turn provides general terminology services.

The present invention enables extension of DL terminologies-including very large ones such as such as SNOMED CT, easily and accurately, using the same language as the original, in multiple independent ways, to meet local and/or specialized needs in a timely manner. As a result, extension namespaces can be associated with a given base namespace, then readily viewed, queried, updated or deleted at will. Prospective extensions from suppliers of base namespaces can be shared, reviewed, tested, and adopted by users on an early basis prior to possible future incorporation within the base. Modular classification can also serve as a vehicle for users to develop their own extensions and propose them to suppliers of base namespaces. This may well expedite requests to terminology curators for new concepts.

The present invention can be generalized and extended in numerous ways, e.g.: multiple levels of extension namespaces; combination of multiple extensions to a base namespace, in any order, on the fly; mutual combinations of namespaces without any one being a base namespace; merging extensions of a base namespace; publishing extensions; workflow over extensions; new concept request, review and approval processes (also referred to as “new term rapid turnaround”) based on modular classification; interaction among extensions, versions and subsets; standalone web service for modular classification; all aspects of modular classification extended to include instances of concepts, i.e., individuals; extensions which also redefine one or more base concepts; extensions which also delete one or more base concepts; multiple independent extensions of taxonomies in general, not just DL taxonomies; likewise for hierarchies or even more generally, for networks; and separate look-aside table for parents and children of base concepts in an extension namespace.

The present invention further comprises a more effective process by which to create, maintain, and deploy a comprehensive structured terminology. The method and system of the present invention described herein are only exemplary. Even though several characteristics and advantages of the present invention have been set forth in the foregoing description together with details of the invention, the disclosure is illustrative only and changes may be made within the principles of the invention to the full extent indicated by the broad general meaning of the terms used in herein and in the attached claims.

What is claimed is:

1. A method of extending a concept taxonomy, comprising:
classifying an extension to a base namespace by updating a classification graph associated with the base namespace according to the extension;
recording results of the classifications separately from the classification graph; and
discarding updates to the classification graph and reverting to the concept taxonomy on demand.

2. The method of claim 1, wherein the results comprise parent-child relationships.

3. The method of claim 1, wherein the classification graph is located within database tables.

4. The method of claim 1, adapted to permit multiple independent extensions of the concept taxonomy.

5. The method of claim 4, wherein a base said classification graph and/or any extension thereof may be accessed on demand without making persistent copies or re-creations of the entire base classification graph.

6. The method of claim 5, wherein the base taxonomy and/or any extension taxonomy may be accessed on demand from suitable database tables without copying or recreating rows for the base namespace.

7. The method of claim 1, further comprising explicitly managing the relationship between the base namespace and one or more extension namespaces to facilitate the extension of the concept taxonomy.

8. A method of extending a concept taxonomy, comprising:
creating and classifying at least one base namespace; and
then creating and classifying at least one extension namespaces associated with the base namespace.

9. The method of claim 8, wherein the method of preparing the at least one base namespace further comprises:
assigning the at least one base namespace a unique GID;
defining an initial set of concepts within the at least one base namespace;
creating a classification graph based on the defined initial set of concepts within the at least one base namespace;
using a classification process, storing the classification graph in a database;
traversing every parent-child relationship in the classification graph, starting from a distinguished root;;
creating a row in a parentage table for each said relationship, with each said row containing a child GID, a parent GID, and the base narnespace GID; and
recording other information inferred about each said concept.

10. The method of claim 9, wherein the defining of the initial set of concepts within the at least one base namespace further comprises recording an identity and definition of each said concept in the database associated with the base namespace GID.

11. The method of claim 9, wherein the method of preparing the at least one extension namespace further comprises:
assigning a unique GID to that at least one extension namespace;
creating a row in the parentage table with the assigned GID of the at least one extension namespace in an extension namespace GID column and the GID of a desired at least one base namespace in a base namespace GID column;
defining an initial set of concepts within the extension namespace; and
classifying the extension namespace.

12. The method of claim 11, further comprising the step of defining an initial set of concepts within the extension namespace, including recording their identities and definitions in a conventional database, in association with the extension namespace GID.

13. The method of claim 11, wherein the method of classifying the extension namespace further comprises:
retrieving the classification graph for a desired said base namespace from the database;
loading the classification graph into a primary memory location;
updating the classification graph in the primary memory location by classifying each said concept of the extension namespace, thereby adding one node per said extension concept to the classification graph;
creating a row in the parentage table containing the GIDs for child C, parent P and the extension namespace for each node N representing the extension concept of the classification graph, for each parent P of node N and for each child C of parent P (including node N); and
creating a row in the parentage table containing the GIDs for C, P, and the extension namespace for each child C of N and for each parent P of C.

14. The method of claim 13, wherein the method of updating an extension namespace further comprises:
redefining the set of concepts within the extension namespace;
removing all rows for the extension namespace from the parentage table; and
classifying the extension namespace.

15. The method of claim 14, wherein the redefining the set of concepts within the extension namespace consists of one from the group of:
adding new concepts by recording their identities and definitions in the database, associated with the extension namespace GID, modifying existing said concepts by updating their definitions in the database, and deleting existing said concepts by removing their identities and definitions from the database.

16. The method of claim 8, further comprising querying the extension namespace.

17. The method of claim 16, wherein the method of querying the extension namespace further comprises retrieving parents and children for base concepts and extension concepts in the extension namespace.

18. The method of claim 8, further comprising monitoring versions of the base namespace and managing changes to the base namespace.

19. The method of claim 18, further comprising generating reports indicative of adversely affected portions of all associated said extension namespaces which reference a modified or deleted said base namespace.

20. A modular classification system, comprising a software program configured to enable a computer having at least a memory, a processor, I/O and data busses, to classify an extension namespace to a base namespace by updating a classification graph associated with the base namespace according to said extension namespace;
the software being further adapted to enable the computer to record the classification results separately from the classification graph; and
the software being further adapted to enable the computer to discard updates to the classification graph and revert to an original concept taxonomy on demand.

21. The system of claim 20, further comprising the computer.

22. The system of claim 20, wherein the software program further comprises an API adapted to implement modular classification operations.

23. The system of claim 20, wherein the software program is adapted to enable the computer to:
create the extension namespace;
associate the extension namespace with the base namespace;
populate the extension namespace with extension concepts defined directly or indirectly in terms of base concepts;
extend the base classification graph by integrating additional nodes as a result of classifying the extension concepts;
save the classification results; and
query the classification results.

24. The system of claim 23, further comprising the software adapted to provide a graphical user interface (“GUI”) for the entry and display of the classification results.

25. The system of claim 24, wherein the GUI is adapted to highlight extensions to the base namespace by rendering an integrated view of the extension namespace.

26. The system of claim 24, wherein the GUI is adapted to provide visual cues related to the nature of the displayed classification results based on typeface and color.

27. The system of claim 26, wherein the displayed classification results typefaces and colors are a finction of whether the displayed classification results are an extension concept or a base concept.

28. The system of claim 24, wherein the GUI provides a “tree walker” interface.
